(19) United States
(12) Patent Application Publication
(10) Pub. No.: US 2014/0171588 A1
(43) Pub. Date: Jun. 19, 2014

(54) COMPOSITION FOR FLEXIBLE SUBSTRATE AND FLEXIBLE SUBSTRATE FORMED FROM THE SAME

(71) Applicant: CHI MEI CORPORATION, Tainan City (TW)

(72) Inventor: Yu-Hao Liang, Kaohsiung City (TW)

(73) Assignee: CHI MEI CORPORATION, Tainan City (TW)

(21) Appl. No.: 14/098,922

(22) Filed: Dec. 6, 2013

(30) Foreign Application Priority Data
Dec. 13, 2012 (TW) 101147208

(51) Int. Cl. C08G 69/26; C08K 5/13; C08K 3/36; C08G 69/42

(52) U.S. Cl. CPC C08G 69/265; C08G 69/42; C08K 5/13; C08K 3/36
USPC 524/600; 528/324

(57) ABSTRACT

A composition for a flexible substrate includes a polymer and a solvent. The polymer is selected from the polyamic acid, polyimide, and a combination thereof, and is obtained by subjecting a mixture including a tetracarboxylic dianhydride component and a diamine component to a reaction. The tetracarboxylic dianhydride component includes a bicyclic alicyclic tetracarboxylic dianhydride compound and a fluorine-containing tetracarboxylic dianhydride compound. The bicyclic alicyclic tetracarboxylic dianhydride compound is in an amount ranging from 30 mole % to 70 mole % and the fluorine-containing tetracarboxylic dianhydride compound is in an amount ranging from 30 mole % to 70 mole % based on 100 mole % of the tetracarboxylic dianhydride component.

### CROSS-REFERENCE TO RELATED APPLICATION

This application claims priority of Taiwanese Application No. 101147208, filed on Dec. 13, 2012.

### BACKGROUND OF THE INVENTION

1. Field of the Invention

This invention relates to a composition for a flexible substrate, more particularly to a composition for a flexible substrate which includes a polymer obtained by subjecting a tetracarboxylic dianhydride component and a diamine component to a polymerization reaction. The tetracarboxylic dianhydride component includes a bicyclic alicyclic tetracarboxylic dianhydride compound and a fluorine-containing tetracarboxylic dianhydride compound. This invention also relates to a flexible substrate formed from the composition.

2. Description of the Related Art

In recent years, organic polymer materials have been used in various electronic components and/or devices to improve properties such as electrical insulation, heat resistance, mechanical property, or the like. A polyimide polymer provides superior mechanical property and better electrical characteristic and thus is most widely used in the art.

JP 2002-293933 discloses a silane-modified polyamic acid composition which is used as an adhesive agent for printed circuit boards. The silane-modified polyamic acid composition includes a solvent and a silane-modified polyamic acid. The silane-modified polyamic acid is obtained by subjecting a polyamic acid and an epoxy-group-containing silane partial condensate to a reaction. A carboxylic acid group of the polyamic acid and the epoxy group of the silane partial condensate react with each other such that the silane partial condensate binds to the tetracarboxylic dianhydride portion of the polyamic acid. However, the silane-modified polyamic acid has inferior thermal stability, and the silane partial condensate would separate from the polyamic acid during heating. The flexible substrate made from the composition has inferior moisture resistance. Thus, when the silane-modified polyamic acid composition is applied for the flexible substrate for flexible liquid crystal display or electronic book (e-book), the moisture resistance thereof cannot meet the industry requirement.

Therefore, it is still required in the art to develop a composition for forming a flexible substrate having better moisture resistance.

### SUMMARY OF THE INVENTION

A first object of the present invention is to provide a composition for a flexible substrate which has superior film-forming capability, and which is suitable for forming a flexible substrate having superior moisture resistance.

A second object of the present invention is to provide a flexible substrate having superior moisture resistance.

According to a first aspect of this invention, there is provided a composition for a flexible substrate which includes a polymer and a solvent. The polymer is selected from the group consisting of polyamic acid, polyimide, and a combination thereof, and is obtained by subjecting a mixture including a tetracarboxylic dianhydride component and a diamine component to a reaction. The tetracarboxylic dianhydride component includes a bicyclic alicyclic tetracarboxylic dianhydride compound and a fluorine-containing tetracarboxylic dianhydride compound. The bicyclic alicyclic tetracarboxylic dianhydride compound is in an amount ranging from 30 mole % to 70 mole % and the fluorine-containing tetracarboxylic dianhydride compound is in an amount ranging from 30 mole % to 70 mole % based on 100 mole % of the tetracarboxylic dianhydride component.

According to a second aspect of this invention, there is provided a flexible substrate formed from the aforesaid composition.

### DETAILED DESCRIPTION OF THE PREFERRED EMBODIMENTS

### Composition for Flexible Substrate:

A composition for a flexible substrate of the present invention includes a polymer and a solvent.

The polymer is selected from the group consisting of polyamic acid, polyimide, and a combination thereof, and is obtained by subjecting a mixture including a tetracarboxylic dianhydride component and a diamine component to a reaction. The tetracarboxylic dianhydride component includes a bicyclic alicyclic tetracarboxylic dianhydride compound and a fluorine-containing tetracarboxylic dianhydride compound. The bicyclic alicyclic tetracarboxylic dianhydride compound is in an amount ranging from 30 mole % to 70 mole % and the fluorine-containing tetracarboxylic dianhydride compound is in an amount ranging from 30 mole % to 70 mole % based on 100 mole % of the tetracarboxylic dianhydride compound.

When the bicyclic alicyclic tetracarboxylic dianhydride compound is less than 30 mole %, the composition for the flexible substrate has not enough viscosity to form a film. When the bicyclic alicyclic tetracarboxylic dianhydride compound is larger than 70 mole %, the flexible substrate formed from the composition has inferior moisture resistance. When the fluorine-containing tetracarboxylic dianhydride compound is less than 30 mole %, the flexible substrate formed from the composition has inferior moisture resistance. When the fluorine-containing tetracarboxylic dianhydride compound is larger than 70 mole %, the composition for the flexible substrate has not enough viscosity to form a film.

Each of components of the composition for the flexible substrate is illustrated in detail as follows:

### Polymer:

The polymer is selected from the group consisting of polyamic acid, polyimide and a combination thereof.

### Polyamic Acid:

A method for preparing the polyamic acid includes the steps of:

(a) dissolving the tetracarboxylic dianhydride component containing the bicyclic alicyclic tetracarboxylic dianhydride compound and the fluorine-containing tetracarboxylic dianhydride compound, and the diamine component in a solvent to form a mixture;

(b) subjecting the mixture to a polymerization reaction at a temperature ranging from 0° C. to 100° C. for a period ranging from 1 hour to 24 hours to obtain a reaction solution; and

(c) distilling the reaction solution under a reduced pressure in a distiller to obtain the polyamic acid.

Alternatively, the reaction solution can be poured into a large amount of poor solvent to obtain a precipitate, which is then dried under a reduced pressure to obtain the polyamic acid.

The tetracarboxylic dianhydride component is used in an amount ranging preferably from 20 moles to 200 moles, and more preferably from 30 moles to 120 moles based on 100 moles of the diamine component.

The solvent for the polymerization reaction may be the same or different from the solvent used in the composition for the flexible substrate. There is no particular limitation to the solvent for the polymerization reaction as long as the solvent is able to dissolve the reactants and the products. Examples of the solvent for the polymerization reaction include, but are not limited to, (1) aprotic polar solvents, such as 1-methyl-2-pyrrolidone, N,N-dimethylacetamide, N,N-dimethylformamide, dimethylsulfoxide, γ-butyrolactone, tetramethylurea, hexamethylphosphoric acid triamide, or the like; and (2) phenolic solvents, such as m-cresol, xylenol, phenol, halogenated phenols, or the like. The solvent for the polymerization reaction is used in an amount ranging preferably from 200 to 2,000 parts by weight, and more preferably from 300 to 1,800 parts by weight based on 100 parts by weight of a combination of the tetracarboxylic dianhydride component and the diamine component.

Particularly, the solvent for the polymerization reaction can be used in combination with a proper amount of a poor solvent as long as the precipitate of the polyamic acid is not formed. Examples of the poor solvent include, but are not limited to, (1) alcohols, such as methyl alcohol, ethyl alcohol, isopropyl alcohol, cyclohexanol, ethylene glycol, propylene glycol, 1,4-butanediol, triethylene glycol, or the like; (2) ketones, such as acetone, methyl ethyl ketone, methyl isobutyl ketone, cyclohexanone, or the like; (3) esters, such as methyl acetate, ethyl acetate, butyl acetate, diethyl oxalate, diethylmalonate, ethylene glycol ethyl ether acetate, or the like; (4) ethers, such as diethyl ether, ethylene glycol methyl ether, ethylene glycol ethyl ether, ethylene glycol n-propyl ether, ethylene glycol i-propyl ether, ethylene glycol n-butyl ether, ethylene glycol dimethyl ether, diethylene glycol dimethyl ether, or the like; (5) halogenated hydrocarbons, such as dichloromethane, 1,2-dichloroethane, 1,4-dichlorobutane, trichloroethane, chlorobenzene, o-dichlorobenzene, or the like; (6) hydrocarbons, such as tetrahydrofuran, hexane, heptane, octane, benzene, toluene, xylene, or the like; and combinations thereof. The aforesaid examples of the poor solvent may be used alone or in admixture of two or more thereof. The poor solvent is used in an amount ranging preferably from 0 to 60 parts by weight, and more preferably from 0 to 50 parts by weight based on 100 parts by weight of the diamine component.

### Polyimide:

A method for preparing the polyimide includes:

(a) dissolving the tetracarboxylic dianhydride component including the bicyclic alicyclic tetracarboxylic dianhydride compound and the fluorine-containing tetracarboxylic dianhydride compound, and the diamine component in a solvent to form a mixture; and

(b) subjecting the mixture to a polymerization reaction to obtain polyamic acid followed by subjecting the polyamic acid to a dehydration/ring-closure reaction, which is conducted by heating in the presence of a dehydrating agent and a catalyst. An amic acid functional group of the polyamic acid compound is converted (i.e., imidization) to an imido functional group via the dehydration/ring-closure reaction so as to obtain the polyimide compound.

The reacting temperature and the reacting time for the polymerization reaction and the dehydration/ring-closure reaction can adopt usual conditions in the art. The heating temperature for the polymerization reaction is in a range preferably from 0° C. to 100° C. The polymerization reaction is conducted in a duration ranging preferably from 1 hour to 24 hours. The heating temperature for the dehydration/ring-closure reaction is in a range preferably from 30° C. to 200° C. The dehydration/ring-closure reaction is conducted in a duration ranging preferably from 0.5 hour to 50 hours.

The solvent for the dehydration/ring-closure reaction can be the same as the solvent used in the composition for the flexible substrate. The solvent for the dehydration/ring-closure reaction is used in an amount ranging preferably from 200 to 2,000 parts by weight, and more preferably from 300 to 1,800 parts by weight based on 100 parts by weight of the polyamic acid.

Examples of the dehydrating agent for the dehydration/ring-closure reaction include, but are not limited to, acid anhydride compounds, such as acetic anhydride, propionic anhydride, trifluoroacetic anhydride, or the like. The dehydrating agent is used in amount ranging from 0.01 mole to 20 moles based on 1 mole of the polyamic acid. Examples of the catalyst for the dehydration/ring-closure reaction include, but are not limited to, pyridine compounds, such as pyridine, trimethylpyridine, dimethylpyridine, or the like; and tertiary amines, such as triethylamine, or the like. The catalyst is used in an amount ranging from 0.5 mole to 10 moles based on 1 mole of the dehydrating agent.

The polyimide has an imidization ratio ranging preferably from 60% to 100%, more preferably from 70% to 99.5%, and most preferably from 80% to 99%. When the polyimide has an imidization ratio ranging from 60% to 100%, the flexible substrate formed therefrom has superior moisture resistance.

### Tetracarboxylic Dianhydride Component:

The tetracarboxylic dianhydride component includes the bicyclic alicyclic tetracarboxylic dianhydride compound and the fluorine-containing tetracarboxylic dianhydride compound.

The bicyclic alicyclic tetracarboxylic dianhydride compound contains a tetravalent bridged hydrocarbon group having a total atom number ranging from 7 to 9 and including a bridge having an atom number of 1 or 2.

The bicyclic alicyclic tetracarboxylic dianhydride compound is selected from the group consisting of
bicyclo[2.2.1]heptane-2,3,5,6-tetracarboxylic dianhydride,
7-azabicyclo[2.2.1]heptane-2,3,5,6-tetracarboxylic dianhydride,
7-oxabicyclo[2.2.1]heptane-2,3,5,6-tetracarboxylic dianhydride,
7-thiabicyclo[2.2.1]heptane-2,3,5,6-tetracarboxylic dianhydride,
6-(carboxymethyl)bicyclo[2.2.1]heptane-2,3,5-tricarboxylic-2,3,5,6-dianhydride,
bicyclo[2.2.2]octane-2,3,5,6-tetracarboxylic dianhydride,
bicyclo[2.2.2]octane-7-ene-2,3,5,6-tetracarboxylic dianhydride,
bicyclo[2.2.2]octane-5-ene-1,2,7,8-tetracarboxylic dianhydride,
bicyclo[2.2.2]octane-2-ene-2,3,5,6-tetracarboxylic dianhydride,
7-azabicyclo[2.2.2]octane-2,3,5,6-tetracarboxylic dianhydride,
7-oxabicyclo[2.2.2]octane-2,3,5,6-tetracarboxylic dianhydride,
7-thiabicyclo[2.2.2]octane-2,3,5,6-tetracarboxylic dianhydride,
bicyclo[3.2.1]octane-2,3,5,6-tetracarboxylic dianhydride,
bicyclo[3.2.1]octane-2,4,5,6-tetracarboxylic dianhydride,
7-azabicyclo[3.2.1]octane-2,3,5,6-tetracarboxylic dianhydride,
7-azabicyclo[3.2.1]octane-2,4,5,6-tetracarboxylic dianhydride,
7-oxabicyclo[3.2.1]octane-2,3,5,6-tetracarboxylic dianhydride,
7-oxabicyclo[3.2.1]octane-2,4,5,6-tetracarboxylic dianhydride,
7-thiabicyclo[3.2.1]octane-2,3,5,6-tetracarboxylic dianhydride,
7-thiabicyclo[3.2.1]octane-2,4,5,6-tetracarboxylic dianhydride,
bicyclo[3.2.2]nonane-2,3,6,7-tetracarboxylic dianhydride,
bicyclo[3.2.2]nonane-2,4,6,7-tetracarboxylic dianhydride,
bicyclo[3.2.2]nonane-8-ene-2,3,6,7-tetracarboxylic dianhydride,
bicyclo[3.2.2]nonane-8-ene-2,4,6,7-tetracarboxylic dianhydride,
8-azabicyclo[3.2.2]nonane-2,3,6,7-tetracarboxylic dianhydride,
8-azabicyclo[3.2.2]nonane-2,4,6,7-tetracarboxylic dianhydride,
8-oxabicyclo[3.2.2]nonane-2,3,6,7-tetracarboxylic dianhydride,
8-oxabicyclo[3.2.2]nonane-2,4,6,7-tetracarboxylic dianhydride,
8-thiabicyclo[3.2.2]nonane-2,3,6,7-tetracarboxylic dianhydride,
8-thiabicyclo[3.2.2]nonane-2,4,6,7-tetracarboxylic dianhydride, and combinations thereof.

The aforesaid examples of the bicyclic alicyclic tetracarboxylic dianhydride compound can be used alone or as a mixture of two or more.

Preferably, the bicyclic alicyclic tetracarboxylic dianhydride compound is selected from
bicyclo[2.2.1]heptane-2,3,5,6-tetracarboxylic dianhydride, 7-oxabicyclo[2.2.1]heptane-2,3,5,6-tetracarboxylic dianhydride,
bicyclo[2.2.2]octane-7-ene-2,3,5,6-tetracarboxylic dianhydride,
bicyclo[2.2.2]octane-2-ene-2,3,5,6-tetracarboxylic dianhydride,
bicyclo[3.2.1]octane-2,3,5,6-tetracarboxylic dianhydride,
7-oxabicyclo[3.2.1]octane-2,3,5,6-tetracarboxylic dianhydride,
bicyclo[3.2.2]nonane-2,3,6,7-tetracarboxylic dianhydride,
bicyclo[3.2.2]nonane-8-ene-2,4,6,7-tetracarboxylic dianhydride,
8-oxabicyclo[3.2.2]nonane-2,3,6,7-tetracarboxylic dianhydride,
8-thiabicyclo[3.2.2]nonane-2,3,6,7-tetracarboxylic dianhydride, and combinations thereof.

The fluorine-containing tetracarboxylic dianhydride compound is selected from the group consisting of 9,9-bis(trifluoromethyl)-9H-xanthene-2,3,6,7-tetracarboxylic dianhydride,

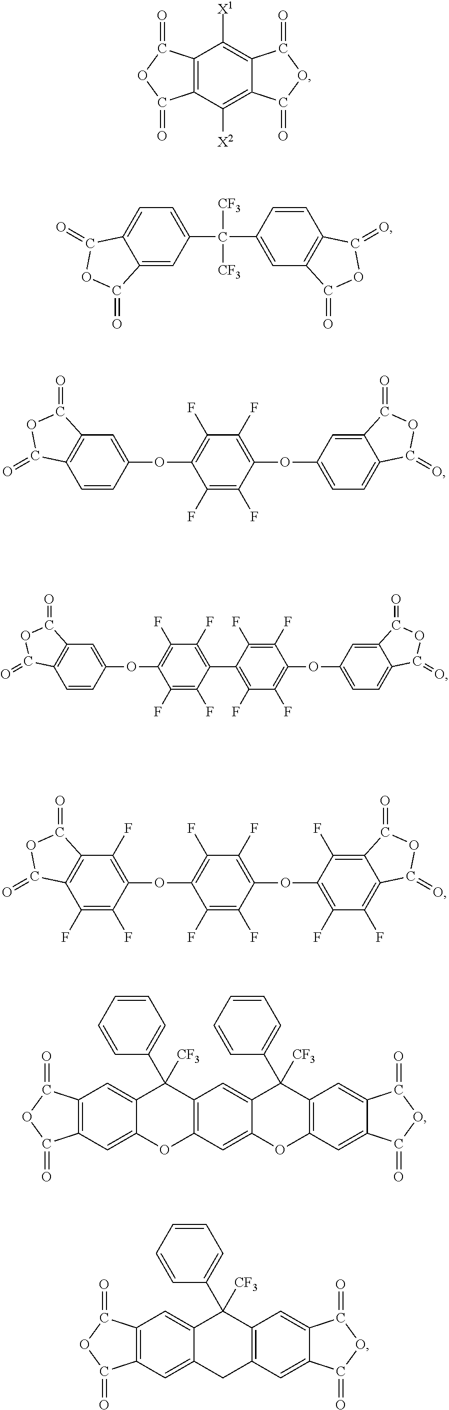

and combinations thereof, wherein at least one of X¹ and X² is fluorine or a trifluoromethyl group.

The aforesaid examples of the fluorine-containing tetracarboxylic dianhydride compound can be used alone or as a mixture of two or more.

Preferably, the fluorine-containing tetracarboxylic dianhydride compound is selected from 9,9-bis(trifluoromethyl)-9H-xanthene-2,3,6,7-tetracarboxylic dianhydride, 1,4-difluoro-2,3,5,6-pyromellitic dianhydride, 3,6-bis(trifluoromethyl)-1,2,4,5-pyromellitic dianhydride,

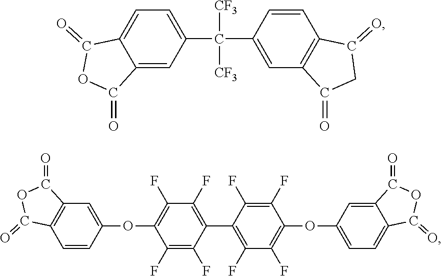 [SMILES: O=C1CC(=O)c2cc(C(c3ccc4c(c3)C(=O)OC4=O)(C(F)(F)F)C(F)(F)F)ccc21 ; O=C1OC(=O)c2cc(Oc3c(F)c(F)c(-c4c(F)c(F)c(Oc5ccc6c(c5)C(=O)OC6=O)c(F)c4F)c(F)c3F)ccc21]

and combinations thereof.

The bicyclic alicyclic tetracarboxylic dianhydride compound is in an amount ranging preferably from 35 mole % to 65 mole %, and more preferably from 40 mole % to 60 mole % based on a total weight of the tetracarboxylic dianhydride component. The fluorine-containing tetracarboxylic dianhydride compound is in an amount ranging preferably from 35 mole % to 65 mole %, and more preferably from 40 mole % to 60 mole % based on a total weight of the tetracarboxylic dianhydride component.

Optionally, the tetracarboxylic dianhydride component can include other tetracarboxylic dianhydride compounds. Examples of the other tetracarboxylic dianhydride compounds include, but are not limited to, ethanetetracarboxylic dianhydride, butanetetracarboxylic dianhydride, 1,2,3,4-cyclobutanetetracarboxylic dianhydride, 1,2-dimethyl-1,2,3,4-cyclobutanetetracarboxylic dianhydride, 1,3-dimethyl-1,2,3,4-cyclobutanetetracarboxylic dianhydride, 1,3-dichloro-1,2,3,4-cyclobutanetetracarboxylic dianhydride, 1,2,3,4-tetramethyl-1,2,3,4-cyclobutanetetracarboxylic dianhydride, 1,2,3,4-cyclopentanetetracarboxylic dianhydride, 1,2,4,5-cyclohexanetetracarboxylic dianhydride, 3,3′,4,4′-dicyclohexanetetracarboxylic dianhydride, cis-3,7-dibutylcycloheptyl-1,5-diene-1,2,5,6-tetracarboxylicdianhydride, 2,3,5-tricarboxylcyclopentylacetic dianhydride, 3,4-dicarboxy-1,2,3,4-tetrahydronaphthalene-1-succinic acid dianhydride, pyromellitic dianhydride, 3,3′,4,4′-benzophenonetetracarboxylic dianhydride, 3,3′,4,4′-biphenylsulfonetetracarboxylic dianhydride, 1,4,5,8-naphthalenetetracarboxylic dianhydride, 2,3,6,7-naphthalenetetracarboxylic dianhydride, 3,3′-4,4′-diphenylethanetetracarboxylic dianhydride, 3,3′,4,4′-dimethyldiphenylsilanetetracarboxylic dianhydride, 3,3,4,4-tetraphenylsilanetetracarboxylic dianhydride, 1,2,3,4-furantetracarboxylicdianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, 3,3′,4,4′-perfluoroisopropylidenediphthalic dianhydride, 3,3′,4,4′-diphenyltetracarboxylic dianhydride, bis(phthalic acid)phenylphosphine oxide dianhydride, p-phenylene-bis(triphenylphthalic acid)dianhydride, m-phenylene-bis(triphenylphthalic acid) dianhydride, bis(triphenylphthalic acid)-4,4′-diphenyl ether dianhydride, bis(triphenylphthalic acid)-4,4′-diphenylmethane dianhydride, ethylene glycol-bis(anhydrotrimellitate), propylene glycol-bis(anhydrotrimellitate), 1,4-butanediol-bis(anhydrotrimellitate), 1,6-hexanediol-bis(anhydrotrimellitate), 1,8-octanediol-bis(anhydrotrimellitate), 2,2-bis(4-hydroxyphenyl)propane-bis(anhydrotrimellitate), 2,3,4,5-tetrahydrofurantetracarboxylicdianhydride, 1,3,3a,4,5,9b-hexahydro-5-(tetrahydro-2,5-dioxo-3-furanyl)-naphtho[1,2-c]-furan-1,3-dione, 1,3,3a,4,5,9b-hexahydro-5-methyl-5-(tetrahydro-2,5-dioxo-3-furanyl)-naphtho[1,2-c]-furan-1,3-dione, 1,3,3a,4,5,9b-hexahydro-5-ethyl-5-(tetrahydro-2,5-dioxo-3-furanyl)-naphtho[1,2-c]-furan-1,3-dione, 1,3,3a,4,5,9b-hexahydro-7-methyl-5-(tetrahydro-2,5-dioxo-3-furanyl)-naphtho[1,2-c]-furan-1,3,-dione, 1,3,3a,4,5,9b-hexahydro-7-ethyl-5-(tetrahydro-2,5-dioxo-3-furanyl)-naphtho[1,2-c]-furan-1,3,-dione, 1,3,3a,4,5,9b-hexahydro-8-methyl-5-(tetrahydro-2,5-dioxo-3-furanyl)-naphtho[1,2-c]-furan-1,3-dione, 1,3,3a,4,5,9b-hexahydro-8-ethyl-5-(tetrahydro-2,5-dioxo-3-furanyl)-naphtho[1,2-c]-furan-1,3-dione, 1,3,3a,4,5,9b-hexahydro-5,8-dimethyl-5-(tetrahydro-2,5-dioxo-3-furanyl)-naphtho[1,2-c]-furan-1,3-dione, and 5-(2,5-dioxotetrahydrofuranyl)-3-methyl-3-cyclohexene-1,2-dicarboxylic dianhydride, the tetracarboxylic dianhydride compounds of Formulas (1)-(6),

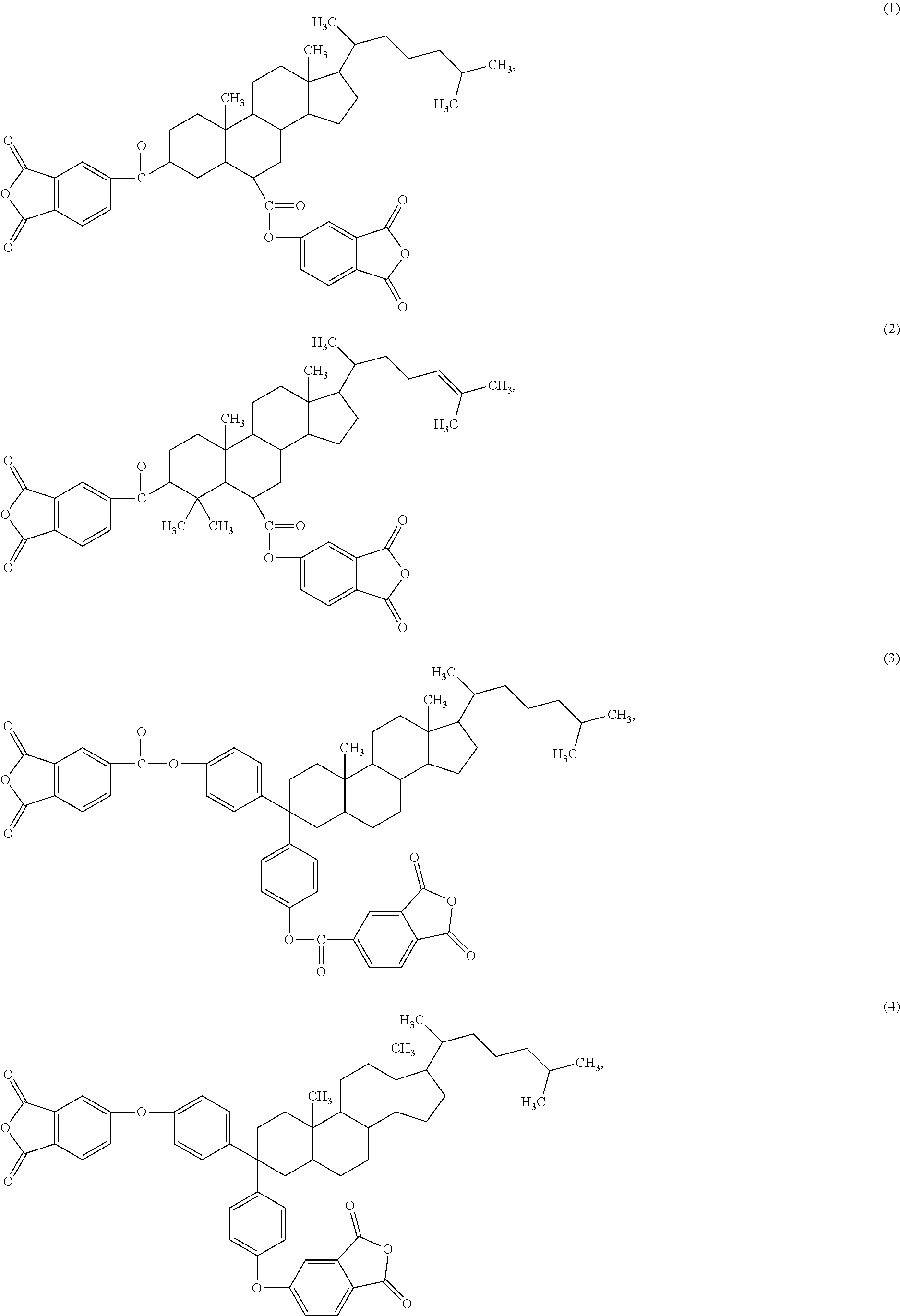 [SMILES: CC(C)CCCC(C)C1CCC2C3CC(C(=O)Oc4ccc5c(c4)C(=O)OC5=O)C4CC(C(=O)c5ccc6c(c5)C(=O)OC6=O)CCC4(C)C3CCC12C ; CC(C)=CCCC(C)C1CCC2C3CC(C(=O)Oc4ccc5c(c4)C(=O)OC5=O)C4C(C)(C)C(C(=O)c5ccc6c(c5)C(=O)OC6=O)CCC4(C)C3CCC12C ; CC(C)CCCC(C)C1CCC2C3CCC4CC(c5ccc(OC(=O)c6ccc7c(c6)C(=O)OC7=O)cc5)(c5ccc(OC(=O)c6ccc7c(c6)C(=O)OC7=O)cc5)CCC4(C)C3CCC12C ; CC(C)CCCC(C)C1CCC2C3CCC4CC(c5ccc(Oc6ccc7c(c6)C(=O)OC7=O)cc5)(c5ccc(Oc6ccc7c(c6)C(=O)OC7=O)cc5)CCC4(C)C3CCC12C]

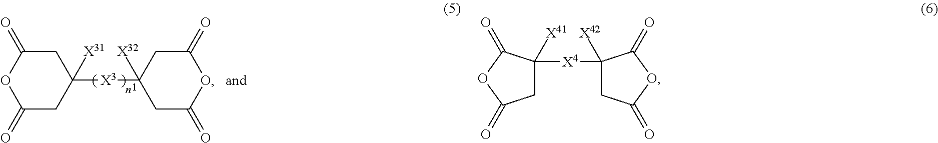

and combinations thereof.

In Formula (5), X³ represents a divalent group having an aromatic ring structure; n¹ represents an integer ranging from 1 to 2; and X³¹ and X³² may be the same or different, and independently represent hydrogen or an alkyl group.

Preferably, the tetracarboxylic dianhydride compound of Formula (5) is selected from the group consisting of

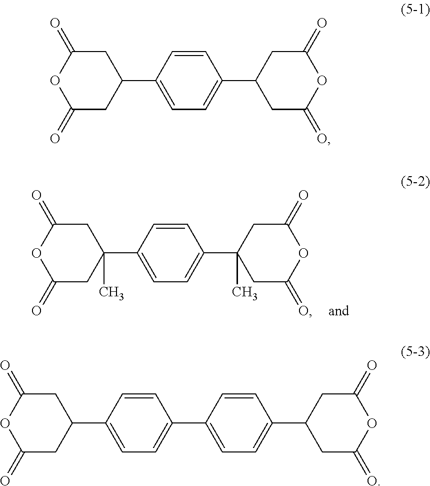

In Formula (6), X⁴ represents a divalent group having an aromatic ring structure; and X⁴¹ and X⁴² may be the same or different, and independently represent hydrogen or an alkyl group.

Preferably, the tetracarboxylic dianhydride compound of Formula (6) is

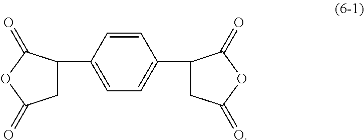 [SMILES: O=C1CC(c2ccc(C3CC(=O)OC3=O)cc2)C(=O)O1]

### Diamine Component:

The diamine component includes a fluorine-containing diamine compound. When the fluorine-containing diamine compound is included in the diamine component, the flexible substrate formed therefrom has superior moisture resistance.

The fluorine-containing diamine compound is selected from the group consisting of 2,2-bis[4-(4-aminophenoxy) phenyl]-1,1,1,3,3,3-hexafluoropropane, 2,2-bis[4-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[3-(3-aminophenoxy)phenyl]-1,1,1,3,3,3-hexafluoropropane, 2,2-bis(4-aminophenyl)-1,1,1,3,3,3-hexafluoropropane, 2,2-bis(3-aminophenyl)-1,1,1,3,3,3-hexafluoropropane, 2,2-bis(3-amino-4-hydroxyphenyl)-1,1,1,3,3,3-hexafluoropropane, bis(2,3,5,6-tetrafluoro-4-aminophenyl)ether, bis(2,3,5,6-tetrafluoro-4-aminophenyl) sulfide, 2,2′-bis(trifluoromethyl)-4,4′-diaminobiphenyl, 3,3′-bis(trifluoromethyl)-4,4′-diaminobiphenyl,

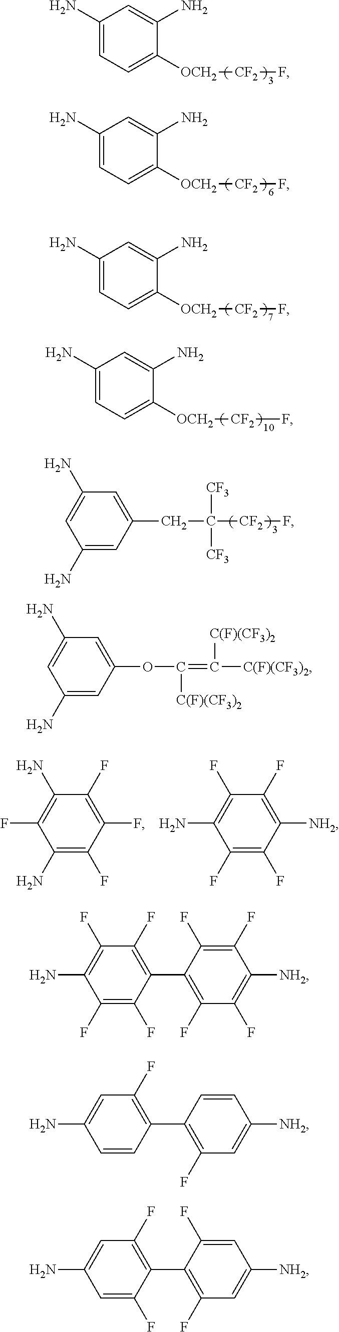

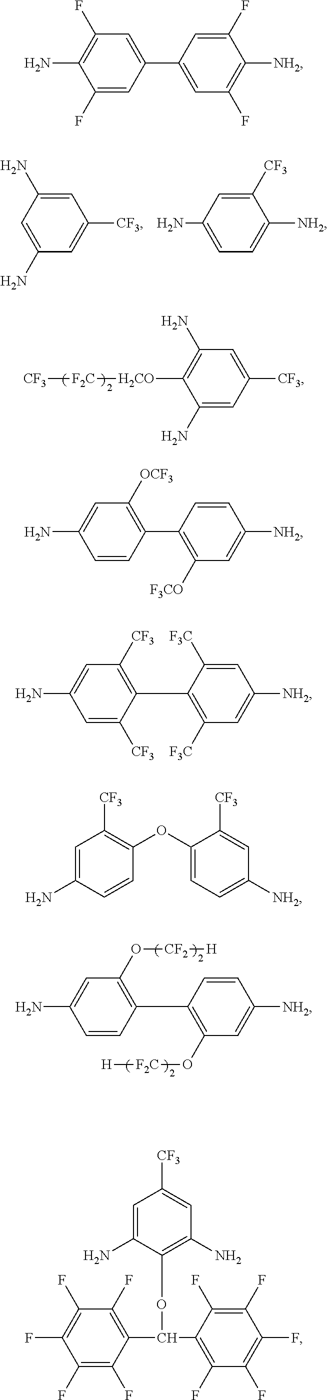

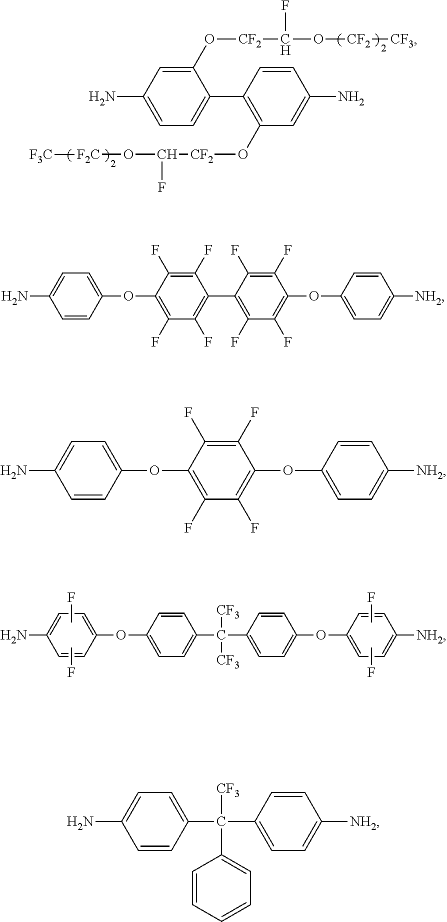

and combinations thereof.

The aforesaid examples of the fluorine-containing diamine compound can be used alone or as a mixture of two or more.

Preferably, the fluorine-containing diamine compound is selected from 2,2-bis[4-(4-aminophenoxy)phenyl]-1,1,1,3,3,3-hexafluoropropane, 2,2-bis(3-aminophenyl)-1,1,1,3,3,3-hexafluoropropane, bis(2,3,5,6-tetrafluoro-4-aminophenyl)ether, 2,2′-bis(trifluoromethyl)-4,4′-diaminobiphenyl,

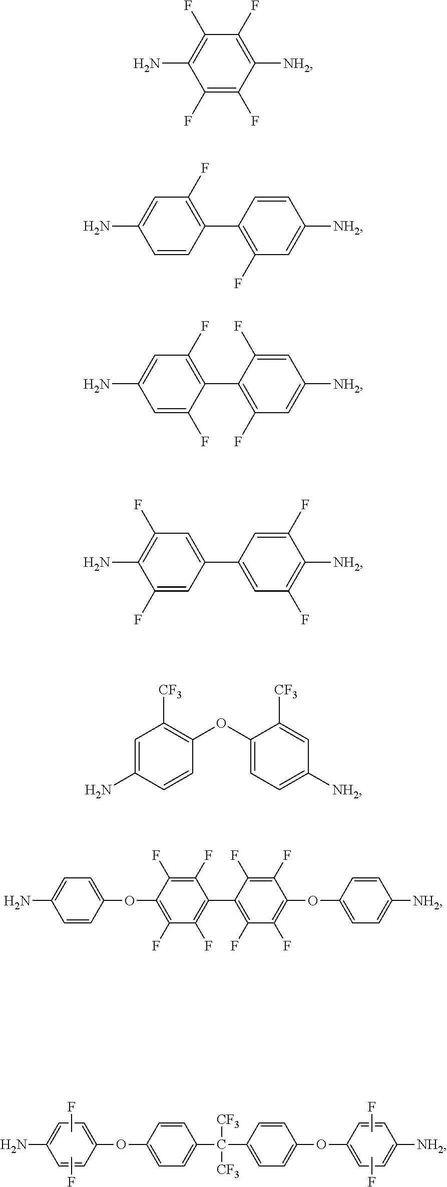

and combinations thereof.

Optionally, the diamine component can include at least one other diamine compound. The fluorine-containing diamine compound is in an amount ranging preferably from 50 mole % to 100 mole %, more preferably from 60 mole % to 100 mole %, and most preferably from 70 mole % to 100 mole % based on a total weight of the diamine component.

Examples of the other diamine compound include, but are not limited to, 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 4,4′-diaminoheptane, 1,3-diamino-2,2-dimethylpropane, 1,6-diamino-2,5-dimethylhexane, 1,7-diamino-2,5-dimethylheptane, 1,7-diamino-4,4-dimethylheptane, 1,7-diamino-3-methylheptane, 1,9-diamino-5-methylnonane, 2,11-diaminododecane, 1,12-diaminooctadecane, 1,2-bis(3-aminopropoxy)ethane, 4,4′-diaminodicyclohexylmethane, 4,4′-diamino-3,3′-dimethyldicyclohexylamine, 1,3-diaminocyclohexane, 1,4-diaminocyclohexane, isophoronediamine, tetrahydrodicyclopentadienylene diamine, tricyclic[6.2.1.0^{2,7}]-undecylenedimethyl diamine, 4,4′-methylenebis(cyclohexylamine), 4,4′-diaminodiphenylmethane, 4,4′-diaminodiphenylethane, 4,4′-diaminodiphenylsulfone, 4,4′-diaminobenzanilide, 4,4′-diaminodiphenylether, 3,4′-diaminodiphenylether, 1,5-diaminonaphthalene, 5-amino-1-(4′-aminophenyl)-1,3,3-trimethylindane, 6-amino-1-(4′-aminophenyl)-1,3,3-trimethylindane, hexahydro-4,7-methanoindanylenedimethylene diamine, 3,3′-diaminobenzophenone, 3,4′-diaminobenzophenone, 4,4′-diaminobenzophenone, 2,2-bis[4-(4-aminophenoxy)phenyl]propane, 2,2-bis[4-(4-aminophenoxy)phenyl]sulfone, 1,4-bis(4-aminophenoxy)benzene, 1,3-bis(4-aminophenoxy)benzene, 1,3-bis(3-aminophenoxy)benzene, 9,9-bis(4-aminophenyl)-10-hydroanthracene, 9,10-bis(4-aminophenyl)anthracene, 2,7-diaminofluorene, 9,9-bis(4-aminophenyl)fluorene, 4,4′-methylene-bis(2-chloroaniline), 4,4′-(p-phenyleneisopropylidene)bisaniline, 4,4′-(m-phenyleneisopropylidene)bisaniline, 5-[4-(4-n-pentylcyclohexyl)cyclohexyl]phenylmethylene-1,3-diaminobenzene, 1,1-bis[4-(4-aminophenoxy)phenyl]-4-(4-ethylphenyl)cyclohexane, the diamine compounds of Formulas (a)-(n),

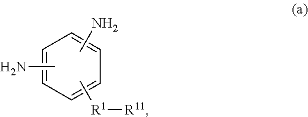

wherein

R¹ represents —O—, —COO—, —OCO—, —NHCO—, —CONH—, or —CO—, and

R¹¹ represents a steroid-containing group, a C₂-C₃₀ alkyl group, or a monovalent nitrogen-containing cyclic structure derived from the group consisting of pyridine, pyrimidine, triazine, piperidine and piperazine,

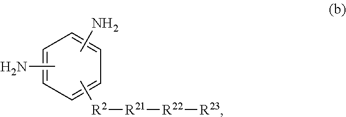

wherein

R² represents —O—, —COO—, —OCO—, —NHCO—, —CONH—, or —CO—,

R²¹ and R²² independently represent a divalent group which is selected from the group consisting of an alicyclic group, an aromatic group, and a heterocyclic group, and

R²³ represents a C₃-C₁₈ alkyl group, a C₃-C₁₈ alkoxy group, a cyano group, or a chlorine atom,

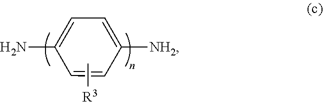

wherein

R³ represents hydrogen, a C₁-C₈ acyl group, a C₁-C₅ alkyl group, a C₁-C₅ alkoxy group, or a chlorine atom,

R³ in each repeating unit may be the same or different, and

n represents an integer ranging from 1 to 3,

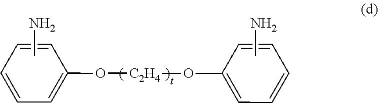

wherein

t represents an integer ranging from 2 to 12,

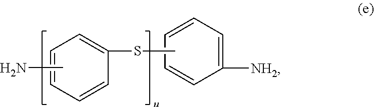

wherein

u represents an integer ranging from 1 to 5,

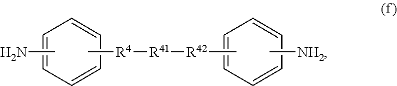

wherein

R⁴ and R⁴² may be the same or different, and independently represent a divalent organic group, and

R⁴¹ represents a divalent nitrogen-containing cyclic structure derived from the group consisting of pyridine, pyrimidine, triazine, piperidine and piperazine,

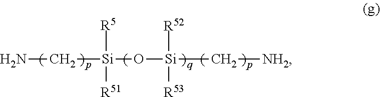

wherein

R⁵, R⁵¹, R⁵² and R⁵³ may be the same or different, and independently represent a C₁-C₁₂ hydrocarbon group,

p represents an integer ranging from 1 to 3, and

q represents an integer ranging from 1 to 20,

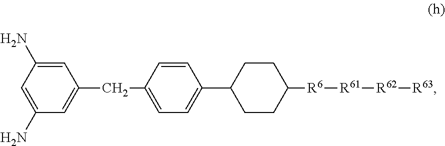

wherein

R⁶ represents —O— or cyclohexylene,

R⁶¹ represents —CH₂—,

R⁶² represents phenylene or cyclohexylene, and

R⁶³ represents hydrogen or a heptyl group,

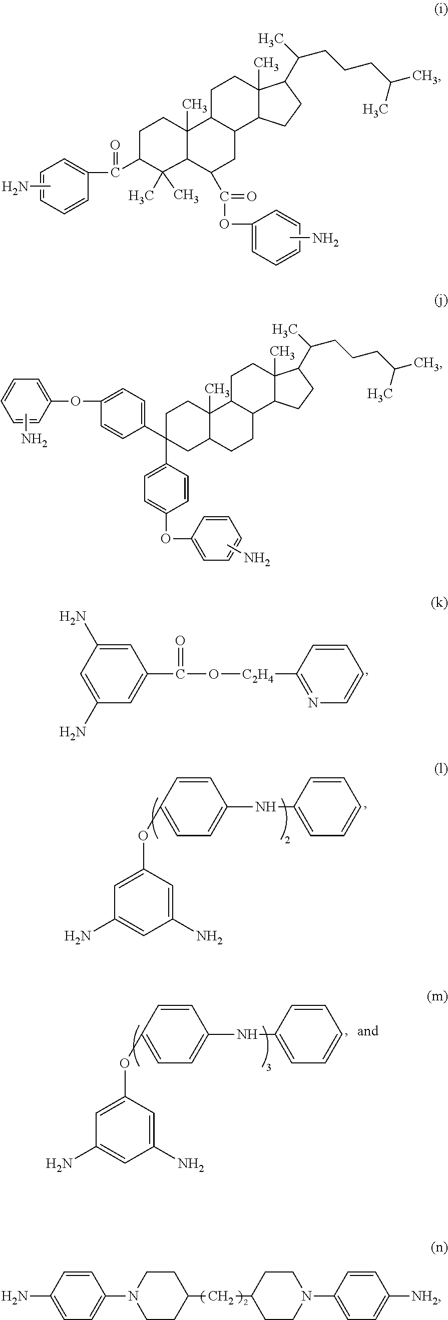

and combinations thereof.

Preferably, examples of the diamine compound of Formula (a) include, but are not limited to, 2,4-diaminophenyl ethyl formate, 3,5-diaminophenyl ethyl formate, 2,4-diaminophenyl propyl formate, 3,5-diaminophenyl propyl formate, 1-dodecoxy-2,4-aminobenzene, 1-hexadecoxy-2,4-aminobenzene, 1-octadecoxy-2,4-aminobenzene,

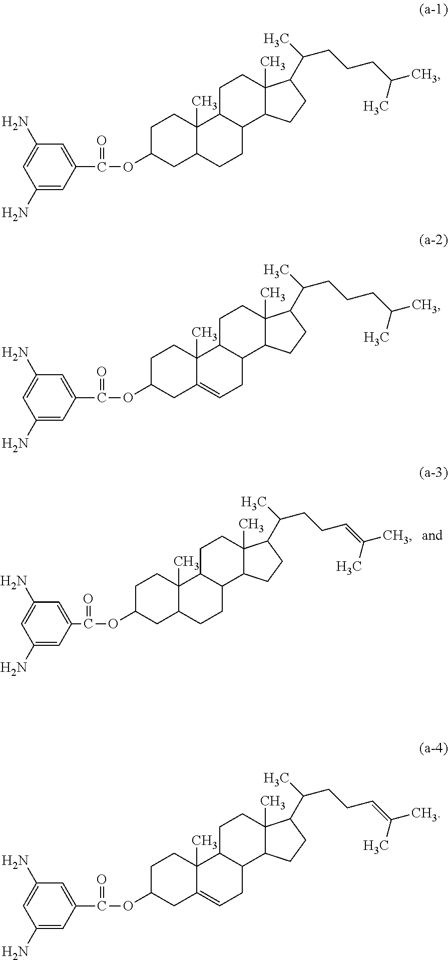 [SMILES: CC(C)CCCC(C)C1CCC2C3CCC4CC(OC(=O)c5cc(N)cc(N)c5)CCC4(C)C3CCC12C ; CC(C)CCCC(C)C1CCC2C3CC=C4CC(OC(=O)c5cc(N)cc(N)c5)CCC4(C)C3CCC12C ; CC(C)=CCCC(C)C1CCC2C3CCC4CC(OC(=O)c5cc(N)cc(N)c5)CCC4(C)C3CCC12C ; CC(C)=CCCC(C)C1CCC2C3CC=C4CC(OC(=O)c5cc(N)cc(N)c5)CCC4(C)C3CCC12C]

Preferably, examples of the diamine compound of Formula (b) include, but are not limited to,

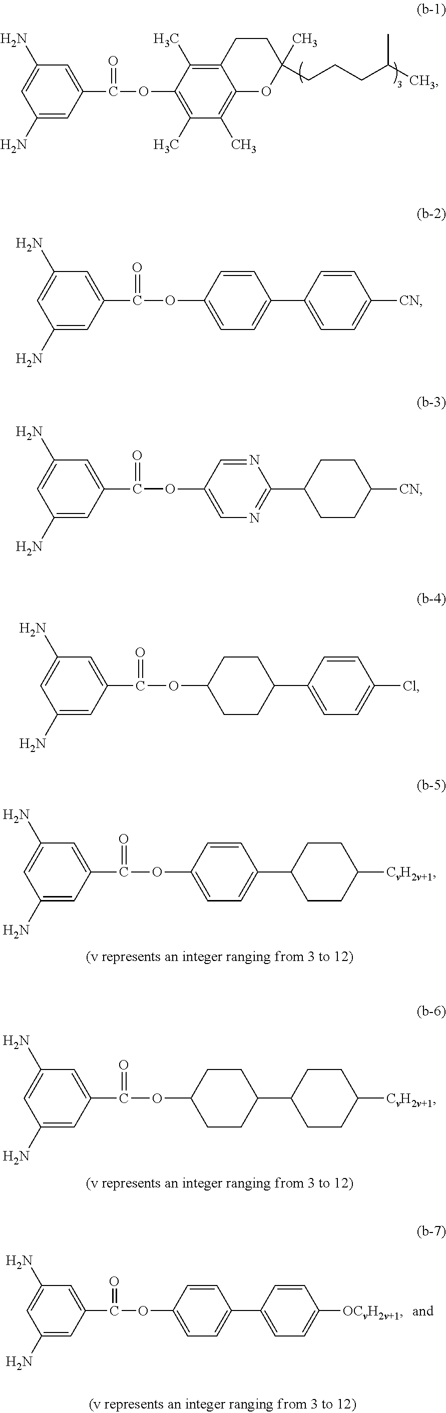

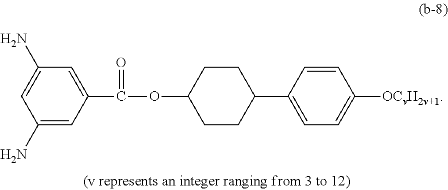

Preferably, examples of the diamine compound of Formula (c) include, but are not limited to, (1) p-diaminobenzene, m-diaminobenzene, o-diaminobenzene, 2,5-diaminotoluene, or the like when n is 1; (2) 4,4′-diaminobiphenyl, 2,2′-dimethyl-4,4′-diaminobiphenyl, 3,3′-dimethyl-4,4′-diaminobiphenyl, 3,3′-dimethoxy-4,4′-diaminobiphenyl, 2,2′-dichloro-4,4′-diaminobiphenyl, 3,3′-dichloro-4,4′-diaminobiphenyl, 2,2′,5,5′-tetrachloro-4,4′-diaminobiphenyl, 2,2′-dichloro-4,4′-diamino-5,5′-dimethoxybiphenyl, or the like when n is 2; and (3) 1,4-bis(4′-aminophenyl)benzene, or the like when n is 3. More preferably, the diamine compound of formula (c) is selected from the group consisting of p-diaminobenzene, 2,5-diaminotoluene, 4,4′-diaminobiphenyl, 3,3′-dimethoxy-4,4′-diaminobiphenyl, 1,4-bis(4′-aminophenyl)benzene, and combinations thereof.

Preferably, the diamine compound of formula (e) is 4,4′-diaminodiphenylsulfide.

Preferably, the diamine compound of formula (h) is selected from the group consisting of

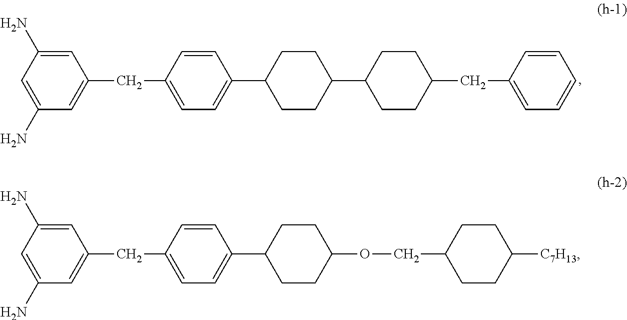

and a combination thereof.

### Solvent:

The solvent for the composition for the flexible substrate is selected from the group consisting of N-methyl-2-pyrrolidone, γ-butyrolactone, γ-butyrolactam, 4-hydroxy-4-methyl-2-pentanone, ethylene glycol monomethyl ether, butyl lactate, butyl acetate, methyl methoxypropionate, ethyl ethoxypropionate, ethylene glycol methyl ether, ethylene glycol ethyl ether, ethylene glycol n-propyl ether, ethylene glycol isopropyl ether, ethylene glycol n-butyl ether, ethylene glycol dimethyl ether, ethylene glycol ethyl ether acetate, diglycol dimethyl ether, diglycol diethyl ether, diglycol monomethyl ether, diglycol monoethyl ether, diglycol monomethyl ether acetate, diglycol monoethyl ether acetate, N,N-dimethylformamide, N,N-dimethylethanamide, and combinations thereof.

### Additives:

An additive can be added into the composition for the flexible substrate as long as the intended properties of the composition for the flexible substrate are not impaired. The additives may be utilized as in the art. Examples of the additives include, but are not limited to, a filler, a plasticizer, a weathering resistant agent, a viscosity modifier, a surface modifying agent, an antioxidant, a defoaming agent, a coloring agent, a thermal stabilizer, an adhesion promoter, a releasing agent, or the like. The aforesaid examples of the additive can be used alone or in admixture.

The additive is used in an amount ranging preferably from 0.1 to 40 parts by weight, and more preferably from 1 to 30 parts by weight based on 100 parts by weight of the polymer.

Examples of the filler include, but are not limited to, silicon dioxide, aluminum oxide, talc, calcium carbonate, calcium sulfate, barium sulfate, titanium dioxide, and the like. Commercially available examples of the filler are products such as IPA-ST (particle size of 12 nm), EG-ST (particle size of 12 nm), IPA-ST-L (particle size of 45 nm), and IPA-ST-ZL (particle size of 100 nm) manufactured by Nissan Chemical Industries, Ltd. The aforesaid examples of the filler can be used alone or in admixture.

Examples of the antioxidant include, but are not limited to, dibutylhydroxytoluene (for example, commercially available products such as BHT manufactured by TCI), 2,6-di-tert-butylphenol, and the like. The aforesaid examples of the antioxidant can be used alone or in admixture.

Examples of the defoaming agent include, but are not limited to, silicon-based defoaming agent (for example, commercially available products such as SH-203 manufactured by Dow Corning Toray), acetylenediol-based defoaming agent (for example, commercially available products such as Surfynol DF-100D, and Surfynol DF-37 manufactured by Nissin Chemical Industry Co., Ltd.), fluorine-containing silicon-based defoaming agent (for example, commercially available products such as FA-630 manufactured by Shin-Etsu Chemical Co., Ltd.), and the like. The aforesaid examples of the defoaming agent can be used alone or in admixture.

When the filler is used, the flexible substrate made from the composition for the flexible substrate has superior film-forming capability.

There is no particular limitation to the method for manufacturing the composition for the flexible substrate of the present invention. A general mixing method can be used. For example, the composition for the flexible substrate of the present invention can be producedby mixing the polyamic acid, the polyimide, the solvents and additives (optional adding), and then stirring thereof until mixed well.

A viscosity of the composition for the flexible substrate can be adjusted according to the method for applying. The viscosity ranges from 1 cps to 20,000 cps.

### Flexible Substrate:

The flexible substrate of the present invention is made from the aforesaid composition for the flexible substrate.

The composition for the flexible substrate can be applied on a base plate using a coating method commonly used in the art, followed by drying and curing treatment. The flexible substrate thus formed is then removed from the base plate. Examples of the coating method include, but are not limited to, spin coating, cast coating, roll coating, or the like.

The drying treatment can be implemented in a manner well known in the art so as to remove the solvent. The drying treatment is conducted at a drying temperature ranging from 50° C. to 200° C. and for a period ranging from 1 minute to 1 hour.

The curing treatment can be implemented in a manner well known in the art so as to completely remove residual solvent and to provide the flexible substrate with a more compact structure. The curing treatment is conducted at a curing temperature ranging from 150° C. to 500° C. and for a period ranging from 10 minutes to 2 hours. The flexible substrate can be removed from the base plate in a manner well known in the art, for example, stripping, dry-etching, wet-etching, or the like.

Examples of the base plate include, but are not limited to, alkali-free glass, soda-lime glass, Pyrex glass, quartz glass, silicon wafer, or the like commonly used in the liquid crystal display device.

The flexible substrate of the present invention is suitable for a flexible liquid crystal display or an electronic book.

The following examples are provided to illustrate the preferred embodiments of the invention, and should not be construed as limiting the scope of the invention.

### EXAMPLES

### Preparation of Polyamic Acid

### Synthesis Example 1

A 500 ml four-necked conical flask equipped with a nitrogen inlet, a stirrer, a condenser and a thermometer was purged with nitrogen, and was added with a feedstock composition including p-diaminobenzene (2.70 g, 0.025 mole), 4,4′-diaminodiphenylmethane (4.95 g, 0.025 mole), and N-methyl-2-pyrrolidone (80 g). Stirring was conducted at room temperature until the aforesaid feedstock composition was dissolved. Bicyclo[2.2.2]octane-2-ene-2,3,5,6-tetracarboxylic dianhydride (6.20 g, 0.025 mole), 3,6-bis(trifluoromethyl)-1,2,4,5-pyromellitic dianhydride (8.85 g, 0.025 mole), and N-methyl-2-pyrrolidone (20 g) were then added to react for 2 hours at room temperature. After the aforesaid reaction, a reaction solution was obtained and then poured into water (1500 ml) to precipitate a polymer. The polymer obtained after filtering was then washed with methanol and filtered three times, and the polymer was then dried in a vacuum oven at 60° C. to obtain a polyamic acid (A-1-1).

### Synthesis Examples 2 to 3

The polyamic acids in Synthesis Examples 2 to 3 were prepared according to the method of Synthesis Example 1 using the tetracarboxylic dianhydride components and the diamine components and the amounts thereof shown in Table 1.

### Preparation of Polyimide

### Synthesis Example 4

A 500 ml four-necked conical flask equipped with a nitrogen inlet, a stirrer, a condenser and a thermometer was purged with nitrogen, and was added with a feedstock composition including p-diaminobenzene (2.70 g, 0.025 mole), 4,4′-diaminodiphenylmethane (4.95 g, 0.025 mole), and N-methyl-2-pyrrolidone (80 g). Stirring was conducted at room temperature until the aforesaid feedstock composition was dissolved. Bicyclo[2.2.2]octane-2-ene-2,3,5,6-tetracarboxylic dianhydride (6.20 g, 0.025 mole), 3,6-bis(trifluoromethyl)-1,2,4,5-pyromellitic dianhydride (8.85 g, 0.025 mole), and N-methyl-2-pyrrolidone (20 g) were then added to react for 6 hours at room temperature. After the aforesaid reaction, the reaction solution was obtained. N-methyl-2-pyrrolidone (97 g), acetate anhydride (5.61 g) and pyridine (19.75 g) were added into the reaction solution. Imidization was conducted by stirring for 2 hours at 60° C. The reaction solution was poured into water (1500 ml) to precipitate a polymer. The polymer obtained after filtering was then washed with methanol and filtered three times, and the polymer was then dried in a vacuum oven at 60° C. to obtain a polyimide (A-2-1).

### Synthesis Examples 5 to 20

The polyimides in Synthesis Examples 5 to 20 were prepared according to the method of Synthesis Example 4 using the tetracarboxylic dianhydride components and the diamine components and the amounts thereof, and the conditions for the dehydration/ring-closure reaction shown in Table 1 and Table 2.

### Preparation of Composition for Flexible Substrate and Flexible Substrate

### Example 1

100 parts by weight of the polyamic acid of Synthesis Example 1 and 800 parts by weight of ethylene glycol n-butyl ether were stirred at room temperature to form a composition for a flexible substrate. The composition for the flexible substrate was applied on a glass substrate board of 100 mm×100 mm×0.7 mm by spin coating to form a film on the glass substrate board. The film was dried at 110° C. for 2 minutes and was then baked at 250° C. for 60 minutes to obtain a substrate body including a flexible substrate disposed on the glass substrate board.

### Examples 2 to 14 and Comparative Examples 1 to 6

The compositions for the flexible substrates and flexible substrates in Examples 2 to 14 and Comparative Examples 1 to 6 were prepared according to the method of Examples 1 using the polymer, the solvent and the additive and the amounts thereof shown in Table 3. The compositions for the flexible substrates and flexible substrates were evaluated according to the following evaluation methods. The results are shown in Table 3.

### Comparative Example 7

A 500 ml four-necked conical flask equipped with a nitrogen inlet, a stirrer, a condenser and a thermometer was purged with nitrogen, and was added with epoxypropanol (commercially available as EPIOL OH manufactured by NOF Co., Ltd., 1400 g) and partial condensate of tetramethoxysilane (commercially available as M Silicate 51 manufactured by Tama Chemicals Co., Ltd., 8957.9 g), followed by continuous stirring and heating to 90° C. Dibutyltin dilaurate catalyst (2.0 g) was then added. About 630 g of methanol was distilled out followed by cooling to room temperature. About 80 g of methanol was further removed via distillation under a reduced pressure of 13 kPa to obtain an alkoxysilane partial condensate containing epoxy group (S1).

A 2 L three-necked conical flask equipped with a nitrogen inlet, a stirrer, a condenser and a thermometer was purged with nitrogen, and was added with polyamic acid (commercially available as Pyre-ML manufactured by I.S.T., 1400 g) and N-methylpyrrolidone (500 g), followed by continuous stirring and heating to 80° C. 39.4 g of alkoxysilane partial condensate containing epoxy group (S1) and 0.23 g of 2-methylimidazole catalyst were then added to react for 4 hours at 80t. The contents of the flask were cooled to room temperature to obtain a silane-modified polyamic acid composition.

The silane-modified polyamic acid composition was applied on a glass substrate board of 100 mm×100 mm×0.7 mm by spin coating to form a film on the glass substrate board. The film was dried at 110° C. for 2 minutes and was then baked at 250° C. for 60 minutes to obtain a substrate body including a flexible substrate disposed on the glass substrate board.

A surface of the flexible substrate on the glass substrate board was observed with naked eyes. Some unevenness was found, but no crack was observed. The flexible substrate on the glass substrate board was removed by a scraper, followed by soaking in water at 60° C. for 24 hours. Moisture absorption of 6% was calculated using a formula in a moisture absorption test, and the evaluation result was X.

### [Evaluation Items]

### 1. Imidization Ratio:

Imidization ratio refers to a ratio of the number of the imide ring to a total of the number of the amic acid functional group and the number of the imide ring in the polyimide, and is represented in percentage. Each of the polymers obtained from Synthesis Examples 1 to 20 was dried under a reduced pressure, and was then dissolved in a proper deuteration solvent, for example, deuterated dimethylsulfoxide. ¹H-NMR determination was conducted at room temperature (for example, 25° C.) using tetramethylsilane as a standard. The imidization ratio (%) was calculated using the following formula:

Imidization Ratio (%)=[1−Δ1/(Δ2×α)]×100

wherein

Δ1 is a peak area produced by a chemical shift around 10 ppm of the proton of NH group;

Δ2 is a peak area of the proton other than that of the NH group; and

α is a ratio of the number of the proton of the NH group to the number of the proton other than that of the NH group in the polymer.

### 2. Film-Forming Capability:

The composition for the flexible substrate of each of Examples 1 to 14 and Comparative Examples 1 to 7 was applied on a glass substrate board of 100 mm×100 mm×0.7 mm by spin coating to form a film on the glass substrate board. The film was dried at 110° C. for 2 minutes and was then baked at 250° C. for 60 minutes to obtain a substrate body including a flexible substrate disposed on the glass substrate board. The surface of the flexible substrate on the glass substrate board was observed with naked eyes and was evaluated according to the standard as follows:
⊚: The surface is without any cracks and very even.
◯: The surface is without any cracks but has some unevenness.
X: The surface has the cracks and the discontinuous blocks.

### 3. Moisture Absorption Test:

Each flexible substrate obtained from the Evaluation Item 2 was removed from the glass substrate board using a scraper. Each flexible substrate was weighed and recorded as W1, and was then soaked in water at 60° C. for 24 hours. The flexible substrate was taken out from the water, was dried with clean cloth and was then weighed and recorded as W2. Moisture absorption (%) was calculated using the following formula:

Moisture Absorption (%)=[(W2−W1)/(W1)]×100%

The moisture absorption of the flexible substrate was evaluated according to the standard as follows:
⊚: Moisture absorption<1.5%;
◯: 1.5% s Moisture absorption<5%;
X: Moisture absorption≧5%;
-: The film can not be formed so that the moisture absorption can not be determined.

TABLE 1

| | | Synthesis Examples | | | | | | | | | |
|---|---|---|---|---|---|---|---|---|---|---|---|
| Components | | 1 | 2 | 3 | 4 | 5 | 6 | 7 | 8 | 9 | 10 |
| Unit: mole (%) | | A-1-1 | A-1-2 | A-1-3 | A-2-1 | A-2-2 | A-2-3 | A-2-4 | A-2-5 | A-2-6 | A-2-1 |
| Tetracarboxylic | a-1-1 | 50 | -- | -- | 50 | -- | -- | 60 | -- | 30 | -- |
| Dianhydride Component | a-1-2 | -- | 40 | -- | -- | 40 | -- | -- | 70 | -- | -- |
| | a-1-3 | -- | -- | 30 | -- | -- | 30 | -- | -- | -- | 30 |
| | a-2-1 | 50 | -- | -- | 50 | -- | -- | 30 | -- | 40 | 40 |
| | a-2-2 | -- | 60 | -- | -- | 60 | -- | -- | -- | 10 | -- |
| | a-2-3 | -- | -- | 70 | -- | -- | 70 | -- | 30 | -- | -- |
| | a-3-1 | -- | -- | -- | -- | -- | -- | -- | -- | -- | 30 |
| | a-3-2 | -- | -- | -- | -- | -- | -- | 10 | -- | -- | -- |
| | a-3-3 | -- | -- | -- | -- | -- | -- | -- | -- | 20 | -- |
| Diamine Component | b-1-1 | -- | -- | 50 | -- | -- | -- | 50 | -- | -- | -- |
| | b-1-2 | -- | -- | -- | -- | -- | 100 | -- | -- | -- | -- |
| | b-2-1 | 50 | 80 | 50 | 50 | 80 | -- | -- | 40 | 100 | 30 |
| | b-2-2 | 50 | -- | -- | 50 | -- | -- | 50 | 60 | -- | -- |
| | b-2-3 | -- | 20 | -- | -- | 20 | -- | -- | -- | -- | 71 |
| Dehydration/ring- | Dehydrating | -- | -- | -- | 5.61 | 5.61 | 6.64 | 6.64 | 7.66 | 8.68 | 8.68 |
| closure reaction | agent (g) | | | | | | | | | | |
| | Catalyst (g) | -- | -- | -- | 19.75 | 19.75 | 19.75 | 20.35 | 19.75 | 20.35 | 19.75 |
| | Temperature | -- | -- | -- | 60 | 60 | 60 | 65 | 60 | 60 | 65 |
| | (° C.) | | | | | | | | | | |
| | Time (hour) | -- | -- | -- | 2 | 3 | 2 | 2 | 2 | 3 | 2 |

| | | | | | | | | | | |
|---|---|---|---|---|---|---|---|---|---|---|
| Imidization Ratio (%) | 0 | 0 | 0 | 38 | 42 | 51 | 57 | 60 | 76 | 84 |

Notes:
┌--┘: not added
a-1-1: bicyclo[2.2.2]octane-2-ene-2,3,5,6-tetracarboxylic dianhydride
a-1-2: 8-thiabicyclo[3.2.2]nonane-2,3,6,7-tetracarboxylic dianhydride
a-1-3: 7-oxabicyclo[2.2.1]heptane-2,3,5,6-tetracarboxylic dianhydride
a-2-1: 3,6-bis(trifluoromethyl)-1,2,4,5-pyromellitic dianhydride
a-2-2: 1,4-difluoro-2,3,5,6-pyromellitic dianhydride
a-2-3: 9,9-bis(trifluoromethyl)-9H-xanthene-2,3,6,7-tetracarboxylic dianhydride
a-3-1: 3,4-dicarboxy-1,2,3,4-tetrahydronaphthalene-1-succinic acid dianhydride
a-3-2: pyromellitic dianhydride
a-3-3: 1,2,3,4-cyclobutanetetracarboxylic dianhydride
b-1-1: bis(2,3,5,6-tetrafluoro-4-aminophenyl)ether
b-1-2: 2,2′-bis(trifluoromethy1)-4,4′-diaminobiphenyl
b-2-1: p-diaminobenzene
b-2-2: 4,4′-diaminodiphenyl methane
b-2-3: 4,4′-diaminodiphenyl ether

TABLE 2

| | | Synthesis Examples | | | | | | | | | |
|---|---|---|---|---|---|---|---|---|---|---|---|
| Components | | 11 | 12 | 13 | 14 | 15 | 16 | 17 | 18 | 19 | 20 |
| Unit: mole (%) | | A-2-8 | A-2-9 | A-2-10 | A-2-11 | A-2-12 | A-2-13 | A-2-14 | A-2-15 | A-2-16 | A-2-17 |
| Tetracarboxylic | a-1-1 | 20 | -- | -- | -- | 25 | -- | -- | 25 | -- | 95 |
| Dianhydride Component | a-1-2 | 20 | 50 | -- | 30 | -- | 60 | 75 | -- | -- | -- |
| | a-1-3 | -- | -- | 40 | 30 | -- | -- | -- | -- | 10 | -- |
| | a-2-1 | -- | -- | -- | -- | 60 | -- | -- | 75 | -- | -- |
| | a-2-2 | -- | 30 | 25 | 40 | -- | 25 | -- | -- | -- | -- |
| | a-2-3 | 60 | -- | 25 | -- | -- | -- | -- | -- | 10 | -- |
| | a-3-1 | -- | 10 | 10 | -- | -- | 15 | -- | -- | 80 | -- |
| | a-3-2 | -- | 10 | -- | -- | 15 | -- | 25 | -- | -- | 5 |
| | a-3-3 | -- | -- | -- | -- | -- | -- | -- | -- | -- | -- |
| Diamine Component | b-1-1 | -- | 80 | -- | 10 | -- | -- | -- | -- | -- | -- |
| | b-1-2 | -- | -- | -- | 10 | -- | -- | -- | -- | 100 | -- |
| | b-2-1 | -- | -- | 80 | -- | 50 | 80 | 40 | 100 | -- | 40 |
| | b-2-2 | 50 | 20 | 20 | -- | 50 | -- | 60 | -- | -- | 60 |
| | b-2-3 | 50 | -- | -- | 80 | -- | 20 | -- | -- | -- | -- |
| Dehydration/ring- | Dehydrating | 8.68 | 9.71 | 9.71 | 6.64 | 5.61 | 5.61 | 7.66 | 8.68 | 6.64 | 7.66 |
| closure reaction | agent (g) | | | | | | | | | | |
| | Catalyst (g) | 21.25 | 19.75 | 19.75 | 19.75 | 19.75 | 19.75 | 20.35 | 19.75 | 21.25 | 19.75 |
| | Temperature | 65 | 70 | 70 | 60 | 60 | 60 | 60 | 60 | 65 | 60 |
| | (° C.) | | | | | | | | | | |
| | Time (hour) | 3 | 3 | 4 | 3 | 2 | 3 | 2 | 3 | 2 | 3 |

| | | | | | | | | | | |
|---|---|---|---|---|---|---|---|---|---|---|
| Imidization Ratio (%) | 92 | 99 | 100 | 54 | 39 | 44 | 63 | 75 | 59 | 63 |

Notes:
┌--┘: not added
a-1-1: bicyclo[2.2.2]octane-2-ene-2,3,5,6-tetracarboxylic dianhydride
a-1-2: 8-thiabicyclo[3.2.2]nonane-2,3,6,7-tetracarboxylic dianhydride
a-1-3: 7-oxabicyclo[2.2.1]heptane-2,3,5,6-tetracarboxylic dianhydride
a-2-1: 3,6-bis(trifluoromethyl)-1,2,4,5-pyromellitic dianhydride
a-2-2: 1,4-difluoro-2,3,5,6-pyromellitic dianhydride
a-2-3: 9,9-bis(trifluoromethyl)-9H-xanthene-2,3,6,7-tetracarboxylic dianhydride
a-3-1: 3,4-dicarboxy-1,2,3,4-tetrahydronaphthalene-1-succinic acid dianhydride
a-3-2: pyromellitic dianhydride
a-3-3: 1,2,3,4-cyclobutanetetracarboxylic dianhydride
b-1-1: bis(2,3,5,6-tetrafluoro-4-aminophenyl)ether
b-1-2: 2,2′-bis(trifluoromethyl)-4,4′-diaminobiphenyl
b-2-1: p-diaminobenzene
b-2-2: 4,4′-diaminodiphenyl methane
b-2-3: 4,4′-diaminodiphenyl ether

TABLE 3

| Components | | Examples | | | | | | | | | | |
|---|---|---|---|---|---|---|---|---|---|---|---|---|
| Unit: parts by weight | | 1 | 2 | 3 | 4 | 5 | 6 | 7 | 8 | 9 | 10 | 11 |
| Polymers | A-1-1 | 100 | -- | -- | -- | -- | -- | -- | -- | -- | -- | -- |
| | A-1-2 | -- | 100 | -- | -- | -- | -- | -- | -- | -- | -- | -- |
| | A-1-3 | -- | -- | 100 | -- | -- | -- | -- | -- | -- | -- | -- |
| | A-2-1 | -- | -- | -- | 100 | -- | -- | -- | -- | -- | -- | -- |
| | A-2-2 | -- | -- | -- | -- | 100 | -- | -- | -- | -- | -- | -- |
| | A-2-3 | -- | -- | -- | -- | -- | 100 | -- | -- | -- | -- | -- |
| | A-2-4 | -- | -- | -- | -- | -- | -- | 100 | -- | -- | -- | -- |
| | A-2-5 | -- | -- | -- | -- | -- | -- | -- | 100 | -- | -- | -- |
| | A-2-6 | -- | -- | -- | -- | -- | -- | -- | -- | 100 | -- | -- |
| | A-2-7 | -- | -- | -- | -- | -- | -- | -- | -- | -- | 100 | -- |
| | A-2-8 | -- | -- | -- | -- | -- | -- | -- | -- | -- | -- | 100 |
| | A-2-9 | -- | -- | -- | -- | -- | -- | -- | -- | -- | -- | -- |
| | A-2-10 | -- | -- | -- | -- | -- | -- | -- | -- | -- | -- | -- |
| | A-2-11 | -- | -- | -- | -- | -- | -- | -- | -- | -- | -- | -- |
| | A-2-12 | -- | -- | -- | -- | -- | -- | -- | -- | -- | -- | -- |
| | A-2-13 | -- | -- | -- | -- | -- | -- | -- | -- | -- | -- | -- |
| | A-2-14 | -- | -- | -- | -- | -- | -- | -- | -- | -- | -- | -- |
| | A-2-15 | -- | -- | -- | -- | -- | -- | -- | -- | -- | -- | -- |
| | A-2-16 | -- | -- | -- | -- | -- | -- | -- | -- | -- | -- | -- |
| | A-2-17 | -- | -- | -- | -- | -- | -- | -- | -- | -- | -- | -- |
| Solvents | B-1 | 800 | 700 | -- | 600 | 1000 | -- | 750 | 800 | 600 | 850 | -- |
| | B-2 | -- | -- | 800 | 100 | -- | 650 | -- | 50 | -- | -- | 300 |
| | B-3 | -- | -- | -- | -- | -- | -- | -- | -- | 400 | -- | 400 |
| Additives | C-1 | -- | -- | -- | -- | -- | 3 | -- | -- | -- | 10 | -- |
| | C-2 | -- | -- | -- | -- | -- | -- | -- | 2 | -- | -- | -- |
| | C-3 | -- | -- | -- | 2 | -- | -- | -- | 3 | -- | -- | -- |
| Results | film-forming | ◯ | ◯ | ◯ | ◯ | ◯ | ⊚ | ◯ | ⊚ | ◯ | ⊚ | ◯ |
| | capability | | | | | | | | | | | |
| | Moisture | ◯ | ◯ | ⊚ | ◯ | ◯ | ⊚ | ⊚ | ⊚ | ⊚ | ⊚ | ⊚ |
| | resistance | | | | | | | | | | | |

| Components | | Examples | | | Comparative Examples | | | | | |
|---|---|---|---|---|---|---|---|---|---|---|
| Unit: parts by weight | | 12 | 13 | 14 | 1 | 2 | 3 | 4 | 5 | 6 |
| Polymers | A-1-1 | -- | -- | -- | -- | -- | -- | -- | -- | -- |
| | A-1-2 | -- | -- | -- | -- | -- | -- | -- | -- | -- |
| | A-1-3 | -- | -- | -- | -- | -- | -- | -- | -- | -- |
| | A-2-1 | -- | -- | -- | -- | -- | -- | -- | -- | -- |
| | A-2-2 | -- | -- | -- | -- | -- | -- | -- | -- | -- |
| | A-2-3 | -- | -- | -- | -- | -- | -- | -- | -- | -- |
| | A-2-4 | -- | -- | -- | -- | -- | -- | -- | -- | -- |
| | A-2-5 | -- | -- | -- | -- | -- | -- | -- | -- | -- |
| | A-2-6 | -- | -- | -- | -- | -- | -- | -- | -- | -- |
| | A-2-7 | -- | -- | -- | -- | -- | -- | -- | -- | -- |
| | A-2-8 | -- | -- | -- | -- | -- | -- | -- | -- | -- |
| | A-2-9 | 100 | -- | -- | -- | -- | -- | -- | -- | -- |
| | A-2-10 | -- | 100 | -- | -- | -- | -- | -- | -- | -- |
| | A-2-11 | -- | -- | 100 | -- | -- | -- | -- | -- | -- |
| | A-2-12 | -- | -- | -- | 100 | -- | -- | -- | -- | -- |
| | A-2-13 | -- | -- | -- | -- | 100 | -- | -- | -- | -- |
| | A-2-14 | -- | -- | -- | -- | -- | 100 | -- | -- | -- |
| | A-2-15 | -- | -- | -- | -- | -- | -- | 100 | -- | -- |
| | A-2-16 | -- | -- | -- | -- | -- | -- | -- | 100 | -- |
| | A-2-17 | -- | -- | -- | -- | -- | -- | -- | -- | 100 |
| Solvents | B-1 | -- | 800 | -- | 800 | 700 | -- | 800 | 600 | 1000 |
| | B-2 | 920 | -- | -- | -- | -- | 800 | -- | 100 | -- |
| | B-3 | -- | -- | 900 | -- | -- | -- | -- | -- | -- |
| Additives | C-1 | -- | -- | -- | -- | -- | -- | -- | -- | -- |
| | C-2 | -- | -- | -- | -- | -- | -- | -- | -- | -- |
| | C-3 | -- | -- | -- | -- | -- | -- | -- | 2 | -- |
| Results | film-forming | ◯ | ◯ | ◯ | X | ◯ | ◯ | X | X | ◯ |
| | capability | | | | | | | | | |
| | Moisture | ⊚ | ⊚ | ⊚ | — | X | X | — | — | X |
| | resistance | | | | | | | | | |

Note:
┌--┘: not added
┌—┘: not determined
B-1: ethylene glycol n-butyl ether
B-2: N-methyl-2-pyrrolidone
B-3: γ-butyrolactone
C-1: silicon dioxide (commercially available as IPA-ST manufactured by Nissan Chemical Industries, Ltd., particle size of 12 nm)
C-2: antioxidant (commercially available as BHT manufactured by TCI)
C-3: defoaming agent (commercially available as SH-203 manufactured by Dow Corning Toray)

As shown in Tables 1, 2 and 3, in each of Examples to 14, the tetracarboxylic dianhydride component including 30 mole % to 70 mole % of bicyclic alicyclic tetracarboxylic dianhydride compound and 30 mole % to 70 mole % of fluorine-containing tetracarboxylic dianhydride compound, and the diamine component were used to obtain a polymer of the composition for the flexible substrate. The composition containing the polymer has superior film-forming capability, and the flexible substrate made from the composition containing the polymer has superior moisture resistance.

In each of Examples 3, 6, 7, 12 and 14, the polymer of the composition for the flexible substrate is obtained using the diamine component further including the fluorine-containing diamine compound. The flexible substrate made from the composition containing the polymer has more superior moisture resistance.

Furthermore, in each of Examples 8 to 13, the polyimide for obtaining the composition for the flexible substrate has an imidization ratio ranging from 60% to 100%, so that the flexible substrate made from the composition for the flexible substrate has more superior moisture resistance.

Additionally, in each of Examples 6 and 10, the filler is added into the composition for the flexible substrate. The flexible substrate thus obtained has more superior film-forming capability.

In Comparative Example 1, the polymer of the composition for the flexible substrate is obtained by subjecting the tetracarboxylic dianhydride component and the diamine component to a reaction, wherein the tetracarboxylic dianhydride component includes 25 mole % of bicyclic alicyclic tetracarboxylic dianhydride compound and 60 mole % of the fluorine-containing tetracarboxylic dianhydride compound. The composition containing the aforesaid polymer has inferior film-forming capability, and the surface of the flexible substrate made from the composition has a lot of cracks.

In Comparative Example 2, the polymer of the composition for the flexible substrate is obtained by subjecting the tetracarboxylic dianhydride component and the diamine component to a reaction, wherein the tetracarboxylic dianhydride component includes 60 mole % of bicyclic alicyclic tetracarboxylic dianhydride compound and 25 mole % of the fluorine-containing tetracarboxylic dianhydride compound. The flexible substrate made from the composition containing the aforesaid polymer has inferior moisture resistance.

In Comparative Example 3, the polymer of the composition for the flexible substrate is obtained by subjecting the tetracarboxylic dianhydride component and the diamine component to a reaction, wherein the tetracarboxylic dianhydride component includes 75 mole % of the bicyclic alicyclic tetracarboxylic dianhydride compound and 25 mole % of the other tetracarboxylic dianhydride compound. The fluorine-containing tetracarboxylic dianhydride compound is not used in the tetracarboxylic dianhydride component. The flexible substrate made from the composition has inferior moisture resistance.

In Comparative Example 4, the polymer of the composition for the flexible substrate is obtained by subjecting the tetracarboxylic dianhydride component and the diamine component to a reaction, wherein the tetracarboxylic dianhydride component includes 25 mole % of the bicyclic alicyclic tetracarboxylic dianhydride compound and 75 mole % of the fluorine-containing tetracarboxylic dianhydride compound. The composition containing the aforesaid polymer has inferior film-forming capability, and the surface of the flexible substrate made from the composition has a lot of cracks.

In Comparative Example 5, the polymer of the composition for the flexible substrate is obtained by subjecting the tetracarboxylic dianhydride component and the diamine component to a reaction, wherein the tetracarboxylic dianhydride component includes 10 mole % of the bicyclic alicyclic tetracarboxylic dianhydride compound and 10 mole % of the fluorine-containing tetracarboxylic dianhydride compound. The fluorine-containing diamine compound is used in the diamine component. However, the composition containing the aforesaid polymer has inferior film-forming capability, and the surface of the flexible substrate made from the composition has a lot of cracks.

In Comparative Example 6, the polymer of the composition for the flexible substrate is obtained by subjecting the tetracarboxylic dianhydride component and the diamine component to a reaction, wherein the tetracarboxylic dianhydride component includes 95 mole % of the bicyclic alicyclic tetracarboxylic dianhydride compound and 5 mole % of the other tetracarboxylic dianhydride compound. The fluorine-containing tetracarboxylic dianhydride compound is not used in the tetracarboxylic dianhydride component. The flexible substrate made from the composition has inferior moisture resistance.

A silane-modified polyamic acid composition of Comparative Example 7 was made according to JP 2002-293933, and the flexible substrate made from the silane-modified polyamic acid composition has inferior moisture resistance.

In summary, when the tetracarboxylic dianhydride component including 30 mole % to 70 mole % of the bicyclic alicyclic tetracarboxylic dianhydride compounds and 30 mole % to 70 mole % of the fluorine-containing tetracarboxylic dianhydride compounds, and the diamine component are used to obtain a polymer, the composition for the flexible substrate containing the aforesaid polymer has superior film-forming capability, and the flexible substrate made from the composition has superior moisture resistance.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A composition for a flexible substrate, comprising:
a polymer selected from the group consisting of polyamic acid, polyimide, and a combination thereof and obtained by subjecting a mixture including a tetracarboxylic dianhydride component and a diamine component to a reaction; and
a solvent,
wherein said tetracarboxylic dianhydride component includes a bicyclic alicyclic tetracarboxylic dianhydride compound and a fluorine-containing tetracarboxylic dianhydride compound, and
wherein said bicyclic alicyclic tetracarboxylic dianhydride compound is in an amount ranging from 30 mole % to 70 mole % and said fluorine-containing tetracarboxylic dianhydride compound is in an amount ranging from 30 mole % to 70 mole % based on 100 mole % of said tetracarboxylic dianhydride component.

2. The composition as claimed in claim 1, wherein said bicyclic alicyclic tetracarboxylic dianhydride compound contains a tetra-valent bridged hydrocarbon group having a total atom number ranging from 7 to 9 and including a bridge having an atom number of 1 or 2.

3. The composition as claimed in claim 1, wherein said bicyclic alicyclic tetracarboxylic dianhydride compound is selected from the group consisting of
bicyclo[2.2.1]heptane-2,3,5,6-tetracarboxylic dianhydride,
7-azabicyclo[2.2.1]heptane-2,3,5,6-tetracarboxylic dianhydride,
7-oxabicyclo[2.2.1]heptane-2,3,5,6-tetracarboxylic dianhydride,
7-thiabicyclo[2.2.1]heptane-2,3,5,6-tetracarboxylic dianhydride,
6-(carboxymethyl)bicyclo[2.2.1]heptane-2,3,5-tricarboxylic-2,3,5,6-dianhydride,
bicyclo[2.2.2]octane-2,3,5,6-tetracarboxylic dianhydride,
bicyclo[2.2.2]octane-7-ene-2,3,5,6-tetracarboxylic dianhydride,
bicyclo[2.2.2]octane-5-ene-1,2,7,8-tetracarboxylic dianhydride,
bicyclo[2.2.2]octane-2-ene-2,3,5,6-tetracarboxylic dianhydride,
7-azabicyclo[2.2.2]octane-2,3,5,6-tetracarboxylic dianhydride,
7-oxabicyclo[2.2.2]octane-2,3,5,6-tetracarboxylic dianhydride,
7-thiabicyclo[2.2.2]octane-2,3,5,6-tetracarboxylic dianhydride,
bicyclo[3.2.1]octane-2,3,5,6-tetracarboxylic dianhydride,
bicyclo[3.2.1]octane-2,4,5,6-tetracarboxylic dianhydride,
7-azabicyclo[3.2.1]octane-2,3,5,6-tetracarboxylic dianhydride,
7-azabicyclo[3.2.1]octane-2,4,5,6-tetracarboxylic dianhydride,
7-oxabicyclo[3.2.1]octane-2,3,5,6-tetracarboxylic dianhydride,
7-oxabicyclo[3.2.1]octane-2,4,5,6-tetracarboxylic dianhydride,
7-thiabicyclo[3.2.1]octane-2,3,5,6-tetracarboxylic dianhydride,
7-thiabicyclo[3.2.1]octane-2,4,5,6-tetracarboxylic dianhydride,
bicyclo[3.2.2]nonane-2,3,6,7-tetracarboxylic dianhydride,
bicyclo[3.2.2]nonane-2,4,6,7-tetracarboxylic dianhydride,
bicyclo[3.2.2]nonane-8-ene-2,3,6,7-tetracarboxylic dianhydride,
bicyclo[3.2.2]nonane-8-ene-2,4,6,7-tetracarboxylic dianhydride,
8-azabicyclo[3.2.2]nonane-2,3,6,7-tetracarboxylic dianhydride,
8-azabicyclo[3.2.2]nonane-2,4,6,7-tetracarboxylic dianhydride,
8-oxabicyclo[3.2.2]nonane-2,3,6,7-tetracarboxylic dianhydride,
8-oxabicyclo[3.2.2]nonane-2,4,6,7-tetracarboxylic dianhydride,
8-thiabicyclo[3.2.2]nonane-2,3,6,7-tetracarboxylic dianhydride,
8-thiabicyclo[3.2.2]nonane-2,4,6,7-tetracarboxylic dianhydride, and combinations thereof.

4. The composition as claimed in claim 1, wherein said fluorine-containing tetracarboxylic dianhydride compound is selected from the group consisting of 9,9-bis(trifluoromethyl)-9H-xanthene-2,3,6,7-tetracarboxylic dianhydride, 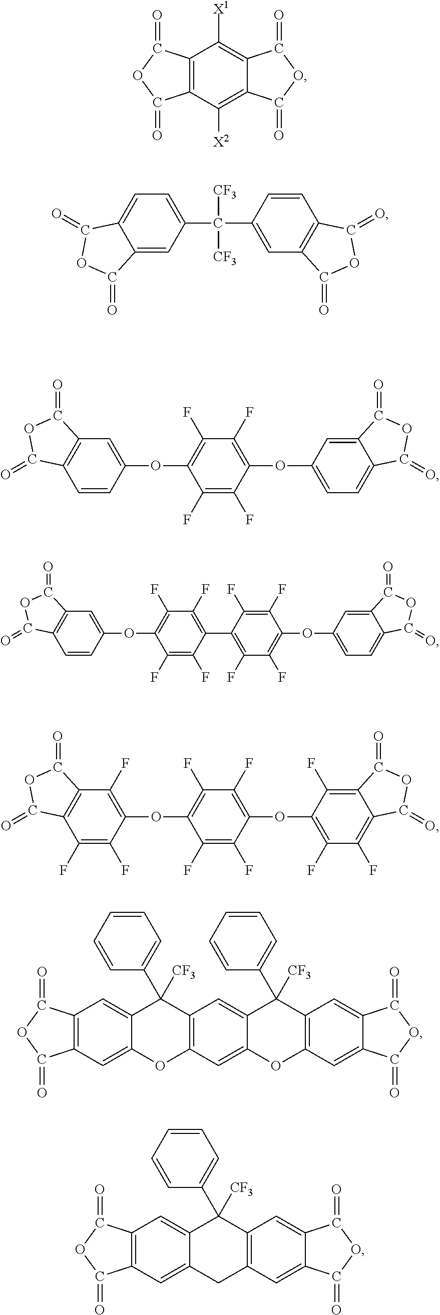
and combinations thereof, wherein at least one of X₁ and X₂ is fluorine or a trifluoromethyl group.

5. The composition as claimed in claim 1, wherein said bicyclic alicyclic tetracarboxylic dianhydride compound is in an amount ranging from 35 mole % to 65 mole % and said fluorine-containing tetracarboxylic dianhydride compound is in an amount ranging from 35 mole % to 65 mole % based on 100 mole % of said tetracarboxylic dianhydride component.

6. The composition as claimed in claim 5, wherein said bicyclic alicyclic tetracarboxylic dianhydride compound is in an amount ranging from 40 mole % to 60 mole % and said fluorine-containing tetracarboxylic dianhydride compound is in an amount ranging from 40 mole % to 60 mole % based on 100 mole % of said tetracarboxylic dianhydride component.

7. The composition as claimed in claim 1, wherein said diamine component includes a fluorine-containing diamine compound.

8. The composition as claimed in claim 7, wherein said fluorine-containing diamine compound is selected from the group consisting of 2,2-bis[4-(4-aminophenoxy)phenyl]-1,1,1,3,3,3-hexafluoropropane, 2,2-bis[4-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[3-(3-aminophenoxy)phenyl]-1,1,1,3,3,3-hexafluoropropane, 2,2-bis(4-aminophenyl)-1,1,1,3,3,3-hexafluoropropane, 2,2-bis(3-aminophenyl)-1,1,1,3,3,3-hexafluoropropane, 2,2-bis(3-amino-4-hydroxyphenyl)-1,1,1,3,3,3-hexafluoropropane, bis(2,3,5,6-tetrafluoro-4-aminophenyl)ether, bis(2,3,5,6-tetrafluoro-4-aminophenyl)sulfide, 2,2′-bis(trifluoromethyl)-4,4′-diaminobiphenyl, 3,3′-bis(trifluoromethyl)-4,4′-diaminobiphenyl, 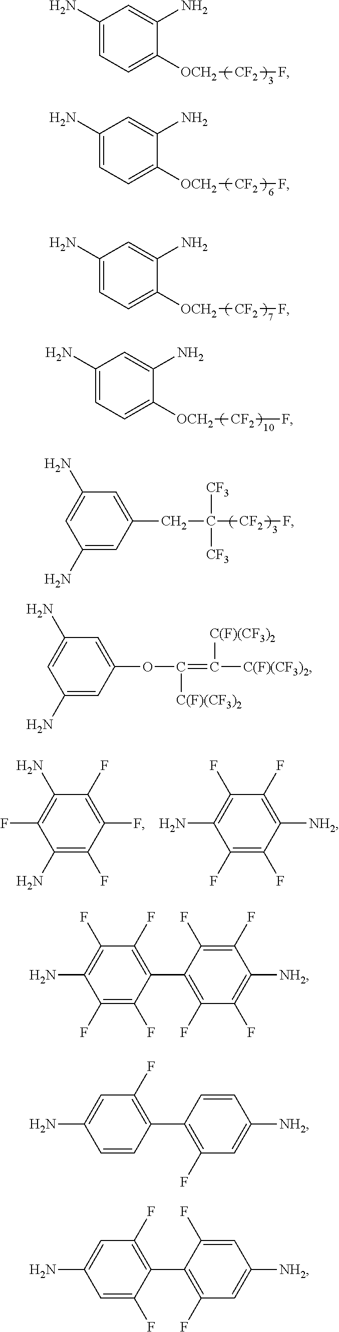 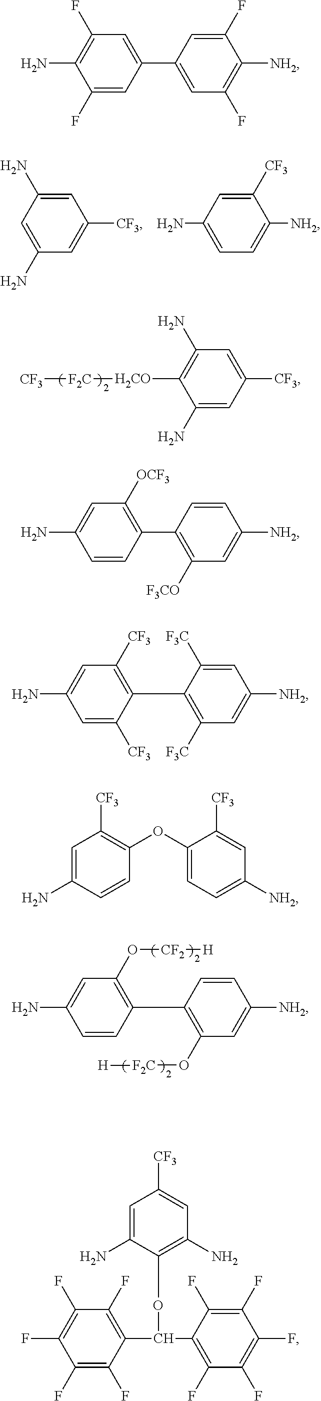 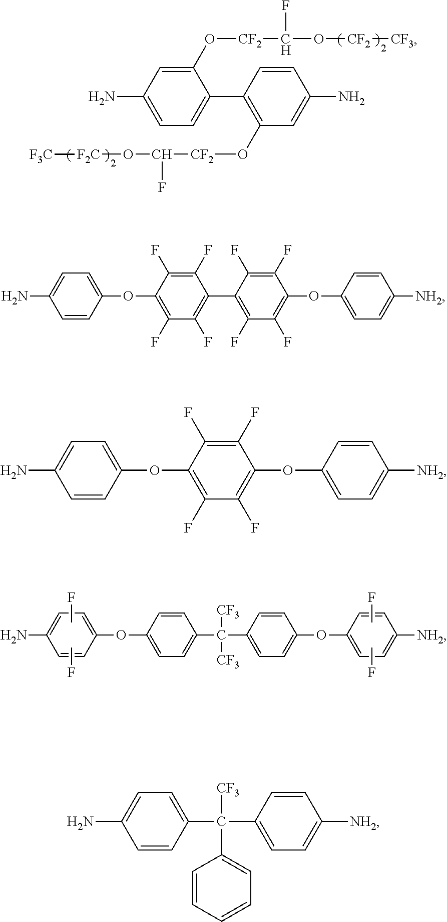
and combinations thereof.

9. The composition as claimed in claim 7, wherein said fluorine-containing diamine compound is in an amount ranging from 50 mole % to 100 mole % based on 100 mole % of said diamine component.

10. The composition as claimed in claim 1, further comprising a filler.

11. The composition as claimed in claim 1, wherein said polyimide has an imidization ratio ranging from 60% to 100%.

12. A flexible substrate formed from the composition as claimed in claim 1.
